(19) United States
(12) Patent Application Publication
(10) Pub. No.: US 2022/0018585 A1
(43) Pub. Date: Jan. 20, 2022

(54) Device for Charging a Refrigerant-Receiving Compartment of a Cooling Container with Dry Ice

(71) Applicant: MESSER GROUP GMBH, Bad Soden (DE)

(72) Inventors: Johanna Schirmacher, Willich (DE); Emir Tebib, Gressy (FR); Jean-Claude Claeys, Zwijndrecht (BE)

(73) Assignee: MESSER GROUP GMBH, Bad Soden (DE)

(21) Appl. No.: 17/299,991

(22) PCT Filed: Dec. 10, 2019
(86) PCT No.: PCT/EP2019/084325

§ 371 Date: Jun. 4, 2021

(30) Foreign Application Priority Data
Dec. 12, 2018 (DE) 10 2018 009 755.3

(51) Int. Cl. F25C 5/20; F25D 3/12; B65G 43/08; B65G 59/06

(52) U.S. Cl. CPC F25C 5/20; F25D 3/125; B65G 2203/0266; B65G 59/067; F25D 2303/0831; B65G 43/08

(57) ABSTRACT

For charging a refrigerant-receiving compartment of a cooling container with dry ice, a reservoir vessel has a dispensing opening and a dispensing unit which cooperates therewith and by means of which dry ice blocks stored in stacks in a magazine of the reservoir vessel are ejected one after the other from the reservoir vessel and are respectively inserted into a refrigerant-receiving compartment of a respectively provided cooling container. This makes it possible to provide cooling containers in rapid succession with a precisely metered quantity of dry ice as refrigerant.

### CROSS-REFERENCE TO RELATED APPLICATIONS

This application is the U.S. national stage application of International Application No. PCT/EP2019/084325, filed Dec. 10, 2019, which International Application was published on Jun. 18, 2020, as International Publication WO 2020/120433 in the German language. The International Application claims priority to German Application No. 10 2018 009 755.3, filed Dec. 12, 2018. The International Application and German Application are hereby incorporated herein by reference, in their entireties.

### FIELD

The invention relates to a device for charging a refrigerant-receiving compartment of a cooling container with dry ice.

### BACKGROUND

Isothermal cooling containers are used for the transportation of heat-sensitive products, in particular foodstuffs in the form of fresh or deep-frozen products, enabling a continuous cooling chain to be guaranteed from production to end customer, even if permanent cooling by an electrically operated cooling appliance is not possible. Cooling containers of this kind usually have a product-receiving compartment for storing the products to be cooled and also a refrigerant-receiving compartment for a cryogenic refrigerant, in particular solid carbon dioxide, which is spatially separate from said product-receiving compartment but is thermally connected.

Cooling containers of this kind are described in EP 0 942 244 A1 or WO 2007/036656 A1, for example. With these objects, the cooling container has a drawer-like receiving compartment for dry ice which is connected thermally and fluidically to a product-receiving compartment arranged thereunder. By means of a specially adapted filling device, the refrigerant-receiving compartment is charged with liquid carbon dioxide which is expanded upon entry with rapid cooling and changes into a mixture of carbon dioxide snow at a temperature of −78° C. and cold carbon dioxide gas at the same temperature. While the carbon dioxide gas is discharged via an extraction system, the carbon dioxide snow is retained and further guarantees cooling of the products through convection or radiation. Due to a corresponding setting of the heat transfer to the product-receiving compartment, the products can be reliably kept at a temperature of 0° C. to 5° C. (for fresh produce) or −15° C. to −25° C. (deep-frozen produce), for example, for a period of up to 24 hours and more.

The cooling containers under discussion are usually of such a size that they can be carried by an operator or moved by means of wheels attached to them. For example, the cooling containers have a basic area of between 400 mm×400 mm and 1200 mm×800 mm and a height of between 400 mm and 2000 mm, with a useful volume of between 15 liters and 2000 liters. Since in many cases even a small amount of dry ice is sufficient to maintain an adequately low cooling temperature over a period of several hours, the receiving compartment for the refrigerant is very much smaller in size than the compartment for receiving the products and has a volume of between 5 liters and 50 liters, for example.

Charging the refrigerant-receiving compartment with liquid carbon dioxide has, in particular, the disadvantage that with devices of this kind, filters which retain the carbon dioxide snow in the receiving compartment must be provided within said receiving compartment. In addition, for safety reasons the carbon dioxide gas occurring during the filling process must be extracted, with the result that corresponding suction devices have to be present at the filling station. Furthermore, the cooling containers are guided to the filling station by an operator individually, one after the other, and charged with liquid carbon dioxide, which takes a substantial amount of time and means that a large number cannot be charged within a short period of time.

Direct charging of the refrigerant-receiving compartment with dry ice pellets or carbon dioxide snow powder, for example, has in turn the disadvantage that the amount of carbon dioxide needed for the cooling function can only be accurately measured with some difficulty and, in addition, during the course of the filling process, moisture penetrating from the ambient atmosphere with the carbon dioxide particles can lead to unwanted water ice formation in the carbon dioxide receiving compartment which makes frequent and time-consuming defrosting of the cooling container necessary.

### SUMMARY

The problem addressed by the invention is therefore that of developing a device for charging a refrigerant-receiving compartment of a cooling container with dry ice which allows a precisely metered amount of dry ice to be introduced into the refrigerant-receiving compartment as quickly as possible, and which therefore also facilitates the filling of a large number of cooling containers with refrigerant in a short period of time.

This problem is solved by a device having the features of patent claim 1.

A device according to the invention therefore has a storage container which is equipped with a feed opening for stackable dry ice slices, a hopper area for storing a stack of dry ice slices, and a dispensing opening arranged in a lower region of the storage container, and also a dispensing unit for the sequential unloading of dry ice slices located in the hopper area through the dispensing opening.

The device according to the invention is used to supply dry ice slices that have already been pre-produced to the refrigerant-receiving compartments of a plurality of cooling containers sequentially, in other words individually in each case or in a prescribed number one after the other. The dry ice blocks are preferably box-shaped blocks with a basic area of 25 cm×25 cm to 40 cm×50 cm, for example, and a height of between 25 cm and 10 cm, for example, which have been pre-produced, for example produced by compressing carbon dioxide snow. They exist either as pure slices of ice or they are individually shrink-wrapped in plastic and are adapted in terms of their dimensions to the respective refrigerant-receiving compartment and/or the respective cooling function. The dry ice slices are introduced into the hopper of the storage container via the feed opening either as slices or individually, manually or by means of a machine. By way of example, 10 to 100 dry ice slices can be stored in the hopper.

A “cooling container” in this case should be understood to mean a transport container for transporting temperature-sensitive products such as foodstuffs or pharmaceutical products, for example, which is equipped with a product-receiving compartment for receiving a product to be cooled and with a refrigerant-receiving compartment which is suitable for receiving a dry ice block or multiple dry ice blocks. For example, the cooling containers have a basic area of between 400 mm×400 mm and 1200 mm×800 mm and a height of between 400 mm and 2000 mm, with a useful volume of between 15 liters and 2000 liters. The refrigerant-receiving compartment has a volume of between 5 liters and 50 liters, for example, and is either integrated in the cooling container or detachably connected thereto. Consequently, the invention facilitates cooling containers with integrated refrigerant-receiving compartments to be filled with dry ice blocks or, however, separate refrigerant-receiving compartments which have been separated from the cooling container in each case and are only reconnected to the remaining part of the respective cooling container following filling. Depending on the arrangement of the dispensing opening of the device according to the invention, the refrigerant-receiving compartment to be filled is either equipped with a feed opening on the upper side or with a side feed opening.

In a first preferred embodiment, the storage container comprises a dispensing opening on the side which is usually arranged in a lower region of the storage container, below the hopper area. On the floor side, the storage container is either closed or open in design; in the latter case, however, it is equipped with means, such as a grid, guide rails, etc., for example, which guarantee a substantially horizontal positioning of the dry ice slices in front of the side dispensing opening and prevent the dry ice slices from falling through the floor. The dispensing unit in this embodiment of the invention is equipped with a horizontally movable sliding element, by means of which one or several of the dry ice slices stored in the hopper area, usually the dry ice slice(s) which is or are lowermost in the stack, are ejected from the storage container at the side. The sliding element in this case is preferably operated using an electrically or pneumatically operated drive unit.

Consequently, the refrigerant-receiving compartment to be filled using this device should have a side feed opening which is aligned with the side dispensing opening of the device during filling, so that the dry ice slices are introduced straight into the refrigerant-receiving compartment by means of the sliding element, or additional guiding means should be present which feed the ejected dry ice slice(s) to a feed opening arranged at the top of the refrigerant-receiving compartment, for example.

An advantageous development of this embodiment of the invention envisages in this case that the dispensing unit has two or more sliding elements arranged above one another which are movable independently of one another. In this way, the number of dry ice slices to be ejected for the respective cooling function can be adapted to the volume of the refrigerant-receiving compartment to be filled in each case or to the required amount of dry ice, for example. When only one dry ice slice is ejected, only the lowermost sliding element is operated in each case, while two or more sliding elements are operated in order to supply multiple dry ice blocks to the refrigerant-receiving compartment simultaneously. Insofar as it is not of variable design due to a movable closing element, the area of the dispensing opening is adapted to the existing sliding elements.

Another preferred embodiment of the invention envisages that the storage container is equipped with a dispensing opening arranged on the underside, so in the floor of the storage container, and the dispensing unit comprises at least two holding devices which each hold the stack of dry ice slices in the hopper area in a first operating position, in order to prevent displacement in a vertical direction, and are released from the stack in a second operating position and thereby allow a vertical movement of said stack.

The first of the two holding devices in this case makes contact with the lowermost slice of dry ice in the stack of dry ice slices located in the hopper area of the storage container in each case. The second holding device makes contact with a slice of dry ice located thereabove, in particular the slice located directly above the lowermost dry ice slice. If the second holding device is moved into the “hold” operating state and the first holding device into the “release” operating state, the lowermost dry ice slice, or all dry ice slices located below the second holding device, are separated from the remainder of the stack and fall through the dispensing opening, while the remainder of the stack is held by the second holding device and remains in the hopper area. In this way, slices of dry ice can be supplied to the refrigerant-receiving compartments in rapid succession one after the other, in particular through alternate operation of the holding devices, said refrigerant-receiving compartments (with or without an associated cooling container) being guided past the dispensing opening one after the other by means of a transport device. The operation of holding devices in this case preferably takes place by means of an electrically or pneumatically operated drive unit.

With this embodiment it is advisable for the refrigerant-receiving compartment preferably to have a feed opening on the upper side; however it is also possible, for example, by means of a guide channel connecting to the dispensing opening, for the dry ice slice(s) falling through the dispensing opening to be fed to a refrigerant-receiving compartment which has a feed opening on the side.

The vertical position of the second holding device on the stack can preferably be variably adjusted in this case and can, for example, be operated manually or based on a preset program by means of a control and monitoring unit. In this way, it is possible for the number of dry ice slices being fed to a refrigerant-receiving compartment to be adjusted to the cooling problem being solved in each case.

A closing element which is arranged on the underside on the storage container is preferably assigned to the dispensing opening. The closing element is particularly used to protect the dispensing opening on the underside from the penetration of moisture from the ambient atmosphere; in addition, it allows thermal insulation of the storage container on the underside thereof. In the embodiment of the invention with a dispensing opening on the side (as described above), these functions are at least partially fulfilled by the sliding element and/or the floor which is fixed there.

The use of pre-produced dry ice slices as the refrigerant for cooling containers allows the supply of a precisely metered quantity of refrigerant to the refrigerant-receiving compartment. The device according to the invention of both aforementioned embodiments in particular allows a refrigerant-receiving compartment to be charged very quickly with a precisely defined quantity of dry ice, so that a large number of refrigerant-receiving compartments can be charged in a short time and without great losses of dry ice, as appropriate. For example, with a device according to the invention, 10-50 and more refrigerant-receiving compartments per minute can be charged with a precisely defined quantity of dry ice.

Advantageously, the device also comprises a transport device by means of which the refrigerant-receiving compartments being charged, or cooling containers which are equipped with a refrigerant-receiving compartment, are transported into a region in front of the dispensing opening and positioned for charging. By means of the transport device, automatic positioning of a cooling container or a refrigerant-receiving compartment in the region of the dispensing opening takes place in such a manner that once the positioning of the cooling container or the refrigerant-receiving compartment has taken place simply through—manual or automatic—operation of the dispensing unit, the corresponding number of dry ice slices is dispensed and directly supplied to the refrigerant-receiving compartment, without further manual settings or adjustments being needed. For example, the transport device comprises a conveying device by means of which a plurality of cooling containers or refrigerant-receiving compartments can be positioned one after the other.

In order to allow a largely automated filling of the refrigerant-receiving compartments, the dispensing unit is preferably data-connected to a control and monitoring unit which is in turn in data connection with a sensor device, by means of which the correct position of a refrigerant-receiving compartment which is to be filled can be detected in front of the dispensing opening. The control and monitoring unit governs the operation of the dispensing unit, depending on the position of a refrigerant-receiving compartment. Optionally, the control and monitoring unit can also assume other functions, such as supplying the correct number of dry ice slices to be fed to a refrigerant-receiving compartment in each case, for example, according to previous programming; likewise, the automatic feed of the transport device can also be controlled by means of the control and monitoring unit or an automatic interruption of the filling process where a fault is detected.

In order to be able to increase the filling frequency still further, a development of the invention envisages that a device for filling multiple refrigerant-receiving compartments comprises two or more filling devices of the aforementioned kind. The filling devices interact with a transport device, on which they are arranged one after the other, viewed in the transport direction of the refrigerant-receiving compartments. When in use, a plurality of refrigerant-receiving compartments is moved past the filling devices by means of the transport device, while the dispensing units of the filling devices are operated in coordinated fashion, such that the refrigerant-receiving compartments are filled with dry ice slices simultaneously or quickly one after the other. The coordinated operation of the filling device and the feed of the transport mechanism are governed by means of a control and monitoring unit in this case too.

### BRIEF DESCRIPTION OF THE DRAWINGS

Exemplary embodiments of the invention are to be explained in greater detail with the help of the drawings. The drawings show in schematic views:

FIG. 1: A device according to the invention in a first embodiment as a vertical sectional view,

FIG. 2: A device according to the invention in a second embodiment as a vertical sectional view.

### DETAILED DESCRIPTION

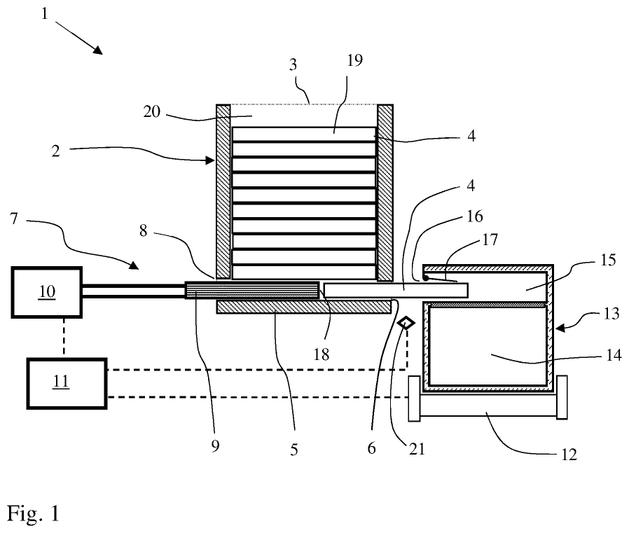

The device 1 shown in FIG. 1 comprises a storage container 2 with thermally well-insulated walls, on the upper side of which a feed opening 3 for dry ice blocks 4 is arranged. The dry ice blocks 4 are box-shaped blocks with a basic area of 25 cm×25 cm to 40 cm×50 cm and a height of between 2.5 cm and 10 cm, for example, which are pre-produced, for example produced by compressing carbon dioxide snow. In the lower region, the storage container 2 ends with a fixed floor 5. Directly above the floor 5 there is a dispensing opening on the side 6.

As shown in the exemplary embodiment, the floor 5 may be a closed and thermally well-insulated floor, however it may also have an open design, for example as a grid, so that small dry ice particles that have broken off the dry ice blocks 4 can fall through, for example, wherein an additional closure part which is not shown here can be provided to prevent the penetration of ambient moisture. In each case, the floor is configured in such a manner that it guarantees a substantially horizontal positioning of the dry ice blocks 4 in the storage container 2.

Furthermore, the storage container 2 is equipped with a dispensing unit 7. The dispensing unit 7 comprises a sliding element 9 which can be moved horizontally through an opening 8 opposite the dispensing opening 6 and which is operated by means of a drive unit 10. The drive unit 10 comprises an electric motor, for example, which is actuated by means of a control unit 11.

Furthermore, the device 1 comprises a transport device 12 by means of which one or multiple cooling containers 13 are automatically fed to the storage container 2 for filling purposes while the device 1 is operating. The cooling container 13 has a product-receiving compartment 14 and a refrigerant-receiving compartment 15. The refrigerant-receiving compartment 15 has a feed opening 16 for supplying dry ice blocks 4 which can preferably be opened and closed using a closing structure 17, for example a closing cap, such that a dry ice block 4 pushed through the feed opening 16 automatically opens the closing structure 17, and the closing structure 17 automatically closes as soon as the dry ice block 4 has been completely introduced into the refrigerant-receiving compartment 15. The refrigerant-receiving compartment 15 is of course designed in such a manner that a dry ice block 4 can easily be inserted into the refrigerant-receiving compartment 15 without there being any risk of it becoming wedged or jammed in the process.

During operation of the device 1, the sliding element 9 is initially located in a position in which it is substantially aligned with its front surface 18 with the inner wall of the storage container 2. Dry ice blocks 4 are then supplied to the storage container 2, said dry ice blocks forming a stack 19 of 10-100 dry ice blocks 4, for example, in a hopper area 20 in the upper part of the storage container 2, wherein the lowermost dry ice block 4 in each case lies horizontally on the floor 5. Once the cooling container 13 has been positioned by means of the transport device 12, in such a manner that the feed opening 16 of the refrigerant-receiving compartment is aligned with the dispensing opening 6, the drive unit 10 is operated and the sliding element 9 pushes the lowermost dry ice block 4 in each case through the dispensing opening 6 and the feed opening 16 into the refrigerant-receiving compartment 15. The sliding element 9 is then pulled back into its starting position and the stack 19 of dry ice blocks 4 remaining in the hopper area 20 falls downwards in the storage container 2 until the dry ice block which is then the lowest rests on the floor 5. At the same time, the closing structure 17 closes the feed opening 16 and the cooling container 13 is transported away by means of the transport device 12 and replaced by a following cooling container 13.

The correct positioning of the feed opening 16 with respect to the dispensing opening 6 is detected by means of a sensor 21, whereof the signals are processed by the control unit 11 for the delivery of corresponding control commands from the control unit 11 to the drive unit 10 and possibly the transport unit 12.

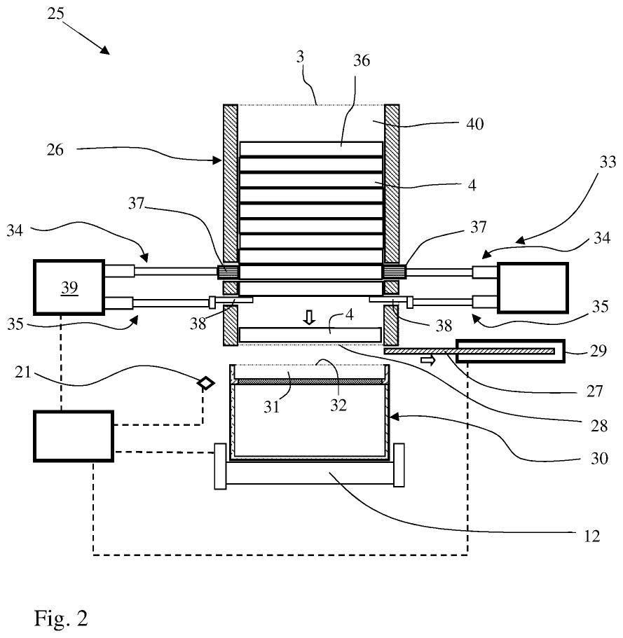

In the case of the exemplary embodiment of a device 25 according to the invention shown in FIG. 2, the same features are labelled using the same reference numbers as in FIG. 1.

The device 25 has a thermally well-insulated storage container 26 with a dispensing opening 28 on the underside. The dispensing opening 28 can be opened and closed using a horizontally displaceable closing element 27. The closing element 27 that can be moved using a drive unit 29 has, in particular, the function of thermally insulating the underside of the storage container 26 and preventing moisture from penetrating from the ambient atmosphere, at least for the most part.

Using the device 25, cooling containers 30 of this kind which are equipped with a refrigerant-receiving compartment 31 with a feed opening 32 on the upper side can, in particular, be charged with dry ice blocks 4.

In the same way as the device 1, the device 25 is also equipped with a dispensing unit 33 which allows the refrigerant-receiving compartment 31 to be charged with individual and/or a prescribed number of dry ice slices 4. For this purpose, the dispensing unit 33 has two holding devices 34, 35 which are arranged vertically above one another on the storage container 26 and which allow a vertical movement of a stack 36 of dry ice slices 4 located in the storage container 26 to be prevented during use.

The holding devices 34, 35 in this case may be differently designed. The holding device 35 in the exemplary embodiment shown here is equipped with laterally displaceable holding plates 38 which engage below the lowermost dry ice block 4 in the stack 36 in a first position, whereas in a second position they are arranged to the side of the stack 36. The holding device 34 is equipped with clamping plates 37 in the exemplary embodiment, which clamping plates fix a dry ice block in a force-fitting manner through lateral pressing against said dry ice block 4, as a result of which all dry ice slices 4 lying thereabove are likewise simultaneously fixed vertically. The holding device 34 engages here on a dry ice plate 4 located above the lowermost dry ice plate 4. The devices 34, 35 are actuated by means of a drive unit 39, operated electrically or hydraulically, for example.

Otherwise, this arrangement of the devices 34, 35 is not obligatory; the two holding devices 34, 35 can also be equipped with holding plates 38 or with clamping plates 37, or the device with holding plates 38 is arranged above the device with clamping plates 37, or other devices may be provided for holding the stack 36.

During operation of the device 25, a hopper area 40 of the storage container 26 located above the holding devices 34, 35 is initially filled with a stack 36 of dry ice slices 4. The holding device 35 projects with the holding plates 38 into the inside of the storage container 26 and thereby prevents the stack 36 from sliding in the direction of the dispensing opening 28. At the same time, the closing element 27 is moved into a position closing the dispensing opening 28 and prevents ambient dampness from penetrating the storage container 26.

The transport device 12 transports cooling containers 30 one after the other beneath the dispensing opening 28 of the device 25. If the presence of a refrigerant-receiving compartment 31 directly below the dispensing opening 28 is detected by the sensor unit 21, the clamping plates 37 of the holding device 34 are displaced in the direction of the stack 36 of dry ice slices 4 until the second lowest dry ice slice 4, and therefore the stack 36 of dry ice slices 4 lying thereabove, is fixed vertically. At the same time, the closing element 27 is displaced into its position releasing the dispensing opening 28. Through lateral displacement of the holding plates 38 of the holding device 35 outwardly, the lowermost dry ice slice 4 is released. It falls under the effects of gravity through the dispensing opening 28 into the refrigerant-receiving compartment 31. The holding plates 38 of the holding device 35 are then advanced back into the inside of the storage container 26 and the clamping plates 37 are released from the dry ice slice 4. The consequence of this is that the remainder of the stack 36 of dry ice slices 4 then falls onto the holding plates 38. The cooling container 30 is then transported on by means of the transport device 12 and replaced by a following cooling container, the refrigerant-receiving compartment of which is to be filled with one or multiple dry ice slice(s). The filled refrigerant-receiving compartment 31 is closed with a cover in a manner not shown here. The closing element 27 can be moved into its closing position after each filling process, or it remains in its opening position during the filling of a series of refrigerant-receiving compartments 31.

Otherwise, the holding device 34 can be moved with its clamping plates 37 vertically in respect of the stack 36, by means of a positioning device which is not shown here. In this way, the number of dry ice slices 4 which are released during detachment of the lower holding device 35 can be varied.

Through the largely automatic operation of the devices 1, 25, cooling containers 13, 30 can be charged with dry ice blocks 4 in very rapid succession, for example at a rate of 10-50 units per minute. Otherwise, the feeding of dry ice blocks 4 to the storage container 2, 26 can also be automated by means of a suitable machine which is not shown here, however.

### LIST OF REFERENCE NUMBERS

1. Device
2. Storage container
3. Feed opening
4. Dry ice block
5. Floor
6. Dispensing opening on the side
7. Dispensing unit
8. Opening
9. Sliding element
10. Drive unit
11. Control unit
12. Transport device
13. Cooling container
14. Product-receiving compartment
15. Refrigerant-receiving compartment
16. Feed opening
17. Closing structure
18. Front surface
19. Stack
20. Hopper area
21. Sensor device
22. -
23. -
24. -
25. Device
26. Storage container
27. Closing element
28. Dispensing opening on the underside
29. Drive unit
30. Cooling container
31. Refrigerant-receiving compartment
32. Feed opening
33. Dispensing unit
34. Holding device
35. Holding device
36. Stack
37. Clamping plate
38. Holding plate
39. Drive unit
40. Hopper area

1. A device for charging a refrigerant-receiving compartment of a cooling container with dry ice, the device comprising a storage container comprising a feed opening for stackable dry ice slices, a hopper area for storing a stack of dry ice slices, and a dispensing opening arranged in a lower region of the storage container, and having a dispensing unit for the sequential unloading of dry ice slices located in the hopper area through the dispensing opening.

2. The device as claimed in claim 1, wherein the dispensing opening is arranged on the side of the storage container and the dispensing unit comprises a horizontally movable sliding element for the sequential pushing-out of the dry ice slices located in the hopper area through the dispensing opening on the side.

3. The device as claimed in claim 2, wherein the dispensing unit has two or more sliding elements arranged above one another.

4. The device as claimed in claim 1, wherein the storage container is equipped with a dispensing opening arranged on the underside and the dispensing unit comprises at least two holding devices which each hold the stack of dry ice slices in the hopper area in a first operating position, in order to prevent displacement in a vertical direction, and allow a vertical movement of said stack in a second operating position, wherein during operation of the device, a first holding device makes contact using holding means with the lowermost dry ice slice of the stack in each case and a second holding device makes contact using holding means with a dry ice slice lying thereabove.

5. The device as claimed in claim 4, wherein the vertical position of the second holding device on the stack can be variably adjusted for holding a dry ice slice.

6. The device as claimed in claim 4, wherein a closing element to protect against moisture from the ambient atmosphere is assigned to the dispensing opening.

7. The device as claimed in claim 1, further comprising a transport device for transporting cooling containers equipped with a refrigerant-receiving compartment into a region in front of the dispensing opening.

8. The device as claimed in claim 1, wherein the dispensing unit is data-connected to a control and monitoring unit which is in turn in data connection with a sensor device, by means of which the presence of a refrigerant-receiving compartment of a cooling container which is to be filled in a region in front of the dispensing opening can be detected.

9. A device for charging a plurality of refrigerant-receiving compartments of cooling containers, characterized by at least two filling devices as claimed in claim 1 which are arranged behind one another on a transport device for transporting refrigerant-receiving compartments in the transport direction of the refrigerant-receiving compartments.
